(19) United States
(12) Patent Application Publication
(10) Pub. No.: US 2003/0018407 A1
(43) Pub. Date: Jan. 23, 2003

(54) Dynamic mold and process

(76) Inventor: Devanand Varma, Windsor (CA)

Correspondence Address: Devanand Varma, 4240 MT Sinai Cr, Windsor, N9G 2G6, CA

(21) Appl. No.: 10/221,441

(22) PCT Filed: Mar. 13, 2001
(86) PCT No.: PCT/CA01/00329

(30) Foreign Application Priority Data
May 1, 2000 (CA) 2306297

(51) Int. Cl. B29C 39/00

(52) U.S. Cl. 700/197; 24/511; 264/219

(57) ABSTRACT

The dynamic mold concept has a manufacture, a process, and an apparatus. The process is that two or more steps (initial processes) be done simultaneously. A blow molding and an injection molding machine can work within the same mold and do their process together at the same time. The dynamic mold allows the mold to be split up into several parts or it has several dies within the structure. It allows the dies to move to allow the part to exit from the mold and move in accordance to do several steps one after the other also. For manufacturing sake for example shear, thermodynamics, temperature demands for quality of product, and for reduced mold design cost, allow two or more processes be done very close together. The dynamic mold is for metal applications as well incorporating a hydroforming, punch and forging etc. application. The process is open to all known manufacturing processes in metal and in plastic and in ceramics and glass and in pelet form as well, and most particles for feed limited that the product or process does not have unsafe processes and products. The manufactures are new products applicable to today's products reducing labor and tooling and hence cost. It will help recycling and aid in the enviroment for example, more hot and cold beverage drinking plastic containers will reduce the cost of plastics considerable and reducing the cost of recycling to fewer products to recycle.

### FIELD OF INVENTION

This invention relates to plastic containers, their manufacture and process and apparatus therefore. The invention relates also to other particle or feed such as metal and emphasis a dynamic molding process to achieve this new way of a cost effective manufacturing process for metals, plastics, glass, ceramics, and so forth.

### BACKGROUND ART AND DISCLOSURE OF INVENTION

The Process

The process is the ability to do two or more processes at one time. For example an injection molding to produce a plastic cup is one process. The second process is a blow molding process to produce a bottle to drink a beverage. The dynamic molding process allows the two processes to be done simultaneously hence saving labor and tooling and possibly machinery. This will save cost and time and increase quality for the product. The dynamic molding process will still allow for one process to be done if required and is not limited to doing both processes. It also allows for the processes to be done very close together in terms of time but not at the same time because of die movements and manufacturing characteristics such as temperature. The process is open to all known manufacturing processes for example gas molding, thermoforming etc. The process is open to all known metal manufacturing process and feeds of pellet shapes and so forth. It will not allow a process to create a dangerous product such as nitrocellulose. It will not be open to process that be harmful to the operators (safe). Feeds that create non harmful or non toxic mixture and as a result of the manufacturing process, a product of non toxic or non harmful substance. The process allows the two part products that end up as one to fuse together in a weld (metal) or solid state weld (metal and plastic etc.) or bonding of the thermoplastic polymers and so forth. If necessary a heated coil be added to ensure the heat weld for the product metal plastic etc. is held. The process is open to do one process as well and not compelled to do more than necessary. The utility is less tooling, less machines and less labor, hence reduced cost and more control of the quality of the product being manufactured.

The Manufacture-Article

The plastic cups market will reduce the paper cups and styrafoam cups because it will have a feature that will allow to hold the cup without heat conduction like paper cups and the weak structure of styrafoam cups (large) that allow spillage of hot water (beverage) occasionally. The plastic cups will have extra plastic thickness at the top of the cups or middle or at the bottom or separate little holdings filled with air insulation as seen in drawings. This will allow the person to drink coffee or tea or hot chacolate or well known beverages usually outside the home. This will allow less usage of styrfoam cups which are considered harmful to the enviroment. This will allow less usage of paper cups which are not comfortable to hold by the person because of the heat conduction of the beverage. As a result much more plastic cups will be marketed. The party cups or thin walled cups that are used once then put out (recycle) are the plastic cups in description.

The plastic is usually PP PE PVC. Polypropelene is one popular example of the type of plastic used. The plastic cup will have an ability to take the hot drink without deforming. The large production for the plastic cup thin walled with thick wall parts for holding will reduce the cost of plastics usually 30 cents a lbs. to 3 cents a lbs. The dynamic molding process will reduce the labor hence a very attractive plastic cup is produced because of its cost and function that is in long felt need. This will push for recycling effective paper and effective plastic container recycling, hence the word environmental cups is associated. The news has stated that recycling is not efficient and takes more energy and is not economical. Waste disposal can for many years be put in 30 mile square area with regular known depths of earth for the U.S. A machine is not feasible in sorting several papers due to limited markets. This long felt need will create paper recycling for office and school papers and newspapers (most common used paper) and create plastic containers for beverages (hot or cold beverages) recycling hence less can beverages. This will make recycling economical and reduce waste and reduce energy. The plastic containers will be available in the fast food industry for wrapping food. The paper and styrafoam application will be in microwave ovens and packaging products such as stereos and so forth.

The plastic cups that have holding part such as extra thickness of plastic is unlimited to other types of insulation such as air insulation or cellular foam plastics or whatever process know such as gas molding to incorporate less material usage and meet the function of insulation at low costs with reasonable looks. The fact that plastic cups had limited plastic thickness in the past due to the high cost of plastic is now open to greater amounts of extra plastics due to the low cost of plastics of a big market and return of plastics through recycling. The material will be much cheaper, the recycling will be much easier. One week papers the next week plastics. This will allow comfortable holding of plastic cups due to a larger holding surface of insulation (air or plastic etc).

The curvature end of the plastic cups in the drawings is around 5 mm thick to wall size around 1 mm thick. This will allow greater ease of holding hot beverages because of the surface area being much larger then in previous designed cups because of the predictable nature a reduced cost for plastics and the reduced labor costs due to dynamic molding process. Large cups have its design as well see drawings.

Fourier's law in heat conduction states that temperature distribution is logarithmic, not linear as it is for plane wall for a cylindrical feature such as the curvature end. Sphere composition is similar. The heat flux with steady state conditions has Tr(radial)=(Ts1−Ts2/(ln(r1/r2) )*ln(r/r2)+T2 where 2 is the fluid cool outside wall and 1 is the fluid hot beverage inside the cup. ;(radius as follows) The conduction through the wall has temperature as a function of the distance from the inner wall to the outside of the wall, hence more distance less hot Tx=(Ts2−Ts1)*x/l+Ts1 where 2 is outside temp cool and 1 is hot beverage hence hotter for shorter distance or thickness in this case for plastic cups.

This also helps cool the beverage at the point of holding at the top (curvature end) quicker than flat wall. The manufacture has all types of packages that have a dual or dual plus process and singular with dynamic molds. The manufacture for cups is also for square designed, triangular, luxury (expensive limited to small production runs). see drawings. The manufactures are all or a bundle of things, tied or in some other way held together due to the dynamic molding process (formed at the same or similar time of two or more processes). The manufacture is open to plastics, metals, ceramics, glass, most feed with limitation as usual general practice avoiding toxic substance.

Function time or FN is the similar time in the dynamic molding process. This FN is in waiting time due to the process. A Ram may come down then form a wall of the product. The second operation is then available to operate such a gas molding hence using the formed wall of the part see drawings. FN is also due to thermodynamic characters such stress recoiling, shear temperature and so forth to control the quality of the product. FN is open to the metal aspect as well for example hydroforming, punch hole, forging, die casting, hot pour casting, etc. FN is also the time to wait for a part die to move for the second process to occur and so forth.

The Apparatus-dynamic Mold and Related Machinery

The unexpected results of the mold having several parts (divided dies) allows for the easy removal of the product when made in the mold. It allows 2 or more process to interact in the mold to do simultaneously several processes. It is also reserved to do one as well. For example to produce a razor plastic it will take 3 steps. One to make the handle for example gas molding would make to a square rod. Then 2 step injection molding makes the head of the razor. The 3 step is to make the heat bond weld of the handle and the head hence causing tooling and labor and time conditions. The dynamic molding machine or apparatus will do this all at once see drawings. The mold is open to processes where it may do the job outside the mold as well and not require a movement of the die or limited movement of the dies in the dynamic mold. The machine will have a mold with all types of features such as ejection holes, evaporation holes, orifice and all present to date manufacturing requirements for all manufacturing process known. The field is vast in this nature hence general requirements are mentioned. The apparatus consisting of a dynamic mold having several dies in that move by a many machinery such as an air piston, hydraulics, servo motors and so forth that are attached to the dies in the mold to allow for dynamic molding process. It will have a housing a table—rotary mold table if necessary—and controls and process machines such as water or injection molding maching or gas molding or blow molding machines to accomplish several processes at one time or within function time. It will have sensors for ram speed and positions PLC micro computers, computers, Internet, data acquisition and closed loop or adoptive controls variable and electric drives, CNC and die bolts and solenoids and so forth. All features do not include essential aspects of the invention due design flexibility and process concept emphasis. The apparatus will encompass the new machines in new technologies that can be applied.

The important element is the dynamic mold and one or more known machines such as blow gas or injection molding, hydroforming, water forming, die casting, etc. for metals and plastic and so forth. The two apparatus are the dynamic mold and the dynamic mold with related machinery. If it is better to leave this in separate inventions, that is up to the examiner.

### DETAILED DESCRIPTION

### Best Modes for Carrying Out the Invention with Brief Description of the Drawings

The process is defined first—the figure shows the different types of molds (dynamic)

In FIG. 1 Operation Type 1a

Die-1 3 moves out only when removal of part is required. First Ram 1 goes down—injection molding process then product 7 is formed then gas molding occurs see the plastic tube 4 for gas molding. The heat bond then occurs since the wall of the injection molding product act as a gas deterrent or stop allowing the process to execute. The top die-1 3 moves out the ejectors 5 push out product. The other die 2 is stationary and equipped with vents, orifice aux. Etc. functions 6. This has function time.

In FIG. 2 Operation Type 1b

Same as the first 1a except top die-1 10 does not to move out when the product 11 is ejected out. In this case the operation can be done at the same time where Ram 9 pushes in dent or dent and Ram 8 is pushed in such as injection molding. Hence the die 10 is stationary yet two processes occurred. The top die 3 can be interchanged with another type of die so that two processes can occur for that particular area of the mold for example punch hole and gas molding etc. This has simultaneously time. The dynamic mold 0 is shown with variations

In FIGS. 3 and 4 Operation Type 2

The top part produces an injection molding and the bottom produces a blow molding. Step 1 is done first creating injection molding product 16 with Ram 12 going down. Then Ram 12 goes up a little then die 14 part of blow molding moves a little for operation of blow molding process 13 to occur. Once this is accomplish then both the top die 15 and bottom die 14 move out so ejection of final product occurs. Die 17 stays stationary. In this case the process required one part to be done first then the other due to mold and application at hand. The product created by the injection molding held down with the ram 16 allow the blow molding to occur hence a bond with the blow molding and injection molding product creating a manufacture. The injection molding part and the Ram 16 help create a die for the blow molding process to occur.

In FIG. 5 Operation Type 3

Multiple tasks where step 1 is the injection molding process operation 18 gas molding process operation 19 and blow molding process operation 20 with 4 dies integrated in the dynamic mold 26 die-1 23 moves out of the way for removal of part and aids in gas molding die-2 22—moves in accordance to steps and process usually programmed through a plc. for dynamic molding process. (And the ejectors 25 or aux.) Multiple task process where process example blow molding A gas molding B injection molding C thermoforming D etc. Z to as many known and to be known is applied. The number of types of processes are unlimited in number (reasonable application). FOR EX type A-A-B will be a gas molding a gas molding and injection molding process With its' dynamic mold. The example in FIG. 5 is A-B-C All types are A, B, C, AA, DC, AB, ABB, ABBA, ADGS, D etc. . . . and so forth

In FIG. 6 Operation Type 4

Two or more process are applied with a fixed mold 27 with Ram 28 and Ram 29 Such as BB

In FIG. 7 Operation Type 5

A similar process which includes metals. The process here is Press Ram 30 and a hydroforming 31 process all applied together related to Operation Type 3 and Type 4 die top 32 moves out of the way die 33 stays stationary. The operation has all known manufacturing process applicable to the dynamic molding process and dynamic mold.

In FIG. 8 Operation Type 6

2 or more process that can be done outside the mold ex. One within the mold and the second outside 35 drill application process 35 Ram press 34 process both for plastic and metal as well as ceramics and glass.

In FIG. 9 The example of the time consuming process of three steps to produce a plastic razor as to a new way of producing a razor through dynamic molding process.

If necessary a heat wire for welding purpose can aid the 6 types of operations mentioned.

FN function time related to product being produced example parts may cool more slowly—molecules have more time to recoil inside. The already solidifying shell setting up stress-production rates are governed by solidification. Open to all (most) pelets of ceramics, glass, plastics, metal pelets, metal (steel) and so forth. *The invention claimed is not limited to the embodiments described—process, apparatus—dynamic mold and in conjunction with machinery-manufacture

The Apparatus

In FIG. 10 an apparatus of a dynamic mold 36 and a machine contain machines for molding and manufacturing processes such as hydroforming and or injection molding machines 34 and 35 connected to a feed 38 and a control box 37 with a housing 39 comprising of elements such a servo motors, hydraulic pumps valves, to attached to the movement of the dynamic die, a table or rotary table for the dynamic mold to be placed on and so forth—orifice, plugs, vents, solenoids, ejectors, springs, die bolts and so forth.

The Manufacture

In FIG. 11 a party thin wall plastic cup 40 having extra thickness of plastic or insulated blow molding part 41 or so forth foam etc. of around 5 mm thick and finger width depth (large hands) around approx. and around 1 mm thick party cup plastic container on today's market material PP, PE, PVC Usually PE and around 10 cm high and around 8 cm diameter

In FIG. 12 thickness is all around cup 42 creating sturdy function and feature

In FIG. 13 thickness is at middle of cup 43

In FIG. 14 thickness is at top and bottom and circular of cup

In FIG. 15 thickness is at top all around and protrudes down the side giving stability preferable to large drink size 45—3 or 2 or more usually sides.

In FIG. 16 different shapes of cups

In FIG. 17 a simple injection molding process where hand lever is created—due to low cost, easy for stacking. Hand from bottom or top 46

In FIG. 18 a bottle 47 created by blow molding a injection molding cup 48 with a gas molding handle 49 and cap 50 or bottle cap to retain beverage in this manufacture of dynamic molding—luxury manufacture package

In FIG. 19 a metal made by dynamic molding process of a hydroforming and bending process.

In FIG. 20 a clip 51 to handle a present type of party cup or a manufacture dynamic molding plastic cup to hold the cup while you drink the cold or hot beverage.

In FIG. 21 clip with handles;

In FIG. 22 clothespin clip with handle to use fingers for better holding 51 and a spring 52 to hold tight.

### SUMMARY

Modifications in the scope of the containers (manufacture) the operation or process dynamic molding and the apparatus machine and dynamic mold and both connected as described are possible without departing from the scope of the invention. For containers it's shapes and material and so forth.

The dynamic molding process allows two or more processes to be done at the same time or function time (closely related to the same time) The dynamic mold has several moveable interchangeable and stationary die within the chamber. It allows the product to move out hence it has an ability to do two processes at the same time and allows one part of the product or process help aid in the process of another hence multiple processes. This concept saves time, tooling.

The material are open to metal, plastics, ceramics and so forth with processes of all known manufacturing processes and to be known. Such as blow molding, injection molding, hydroforming, die casting etc.

Environmental cups are of many new products developed due reduced labor and enhanced quality and large production runs from this dynamic molding process, apparatus and its manufacture or article.

### SUMMARY OF DRAWINGS

FIG. 1 through FIG. 8 are section views of the dynamic mold. It has it's separate die and manufacturing processes and related parts.

FIG. 9 the present processes

FIG. 10 the apparatus(s)

FIGS. 11 through 17 are front and top views of plastic containers-manufacture

FIG. 18 luxury container

FIG. 19 metal manufacture

FIG. 20 clip and cup application

FIGS. 21 and 22 clothespin with handle extended for holding

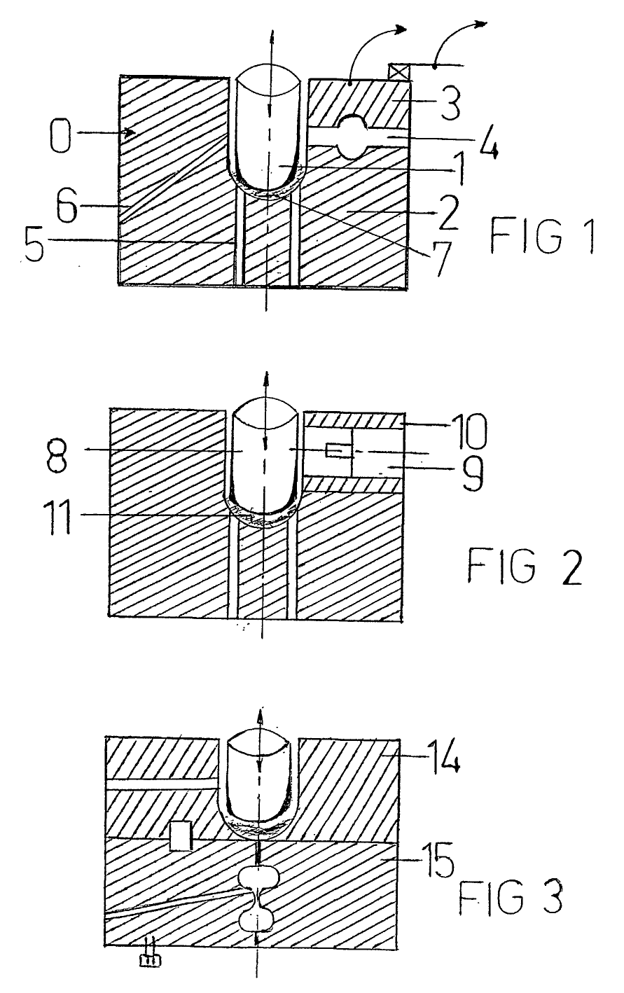

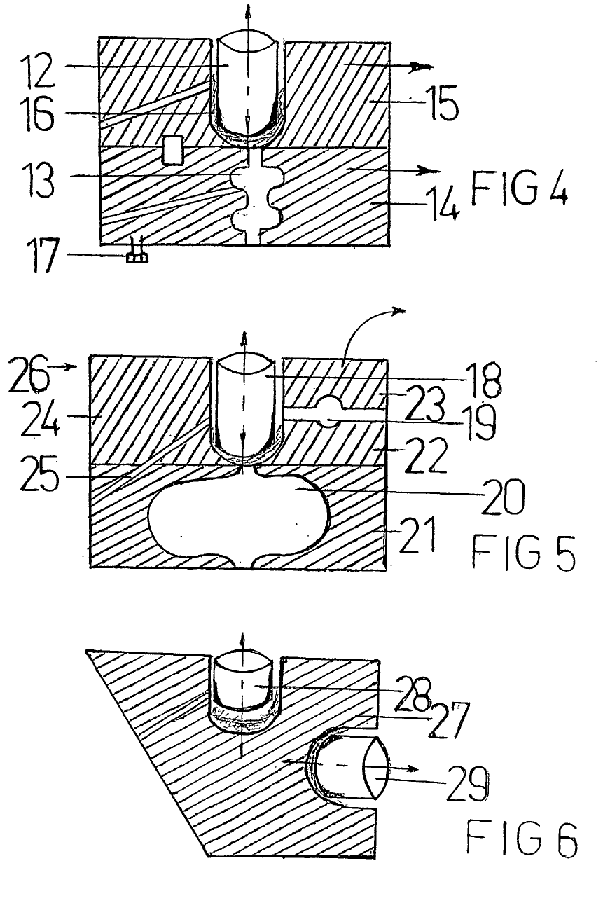

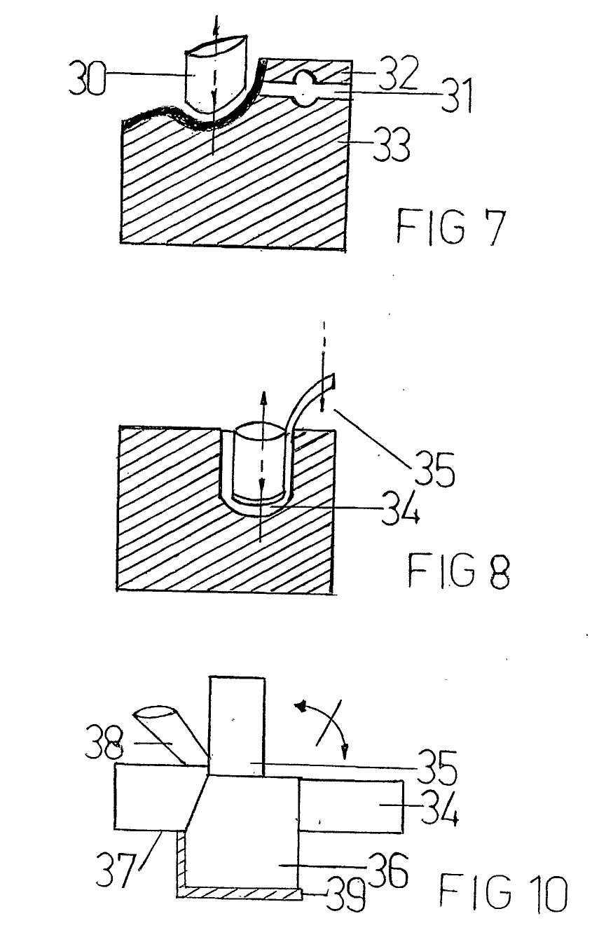

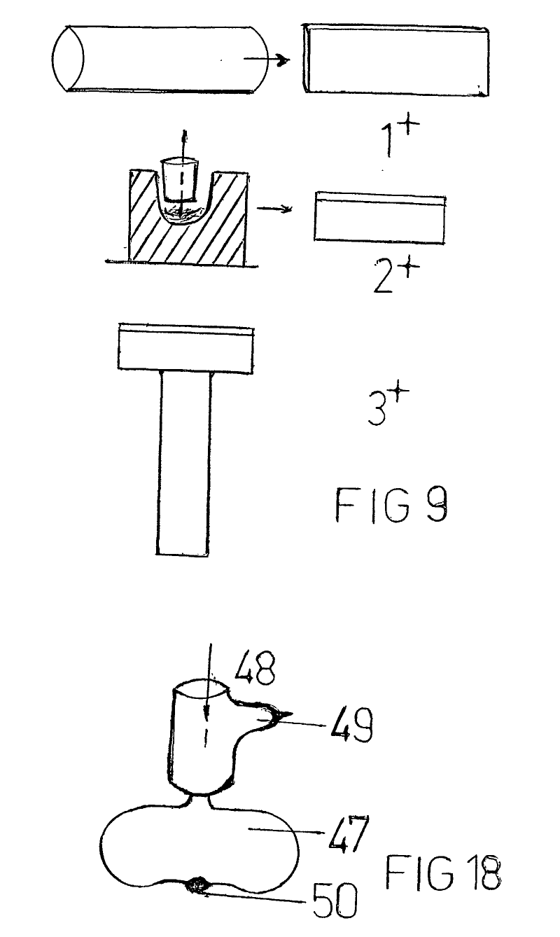

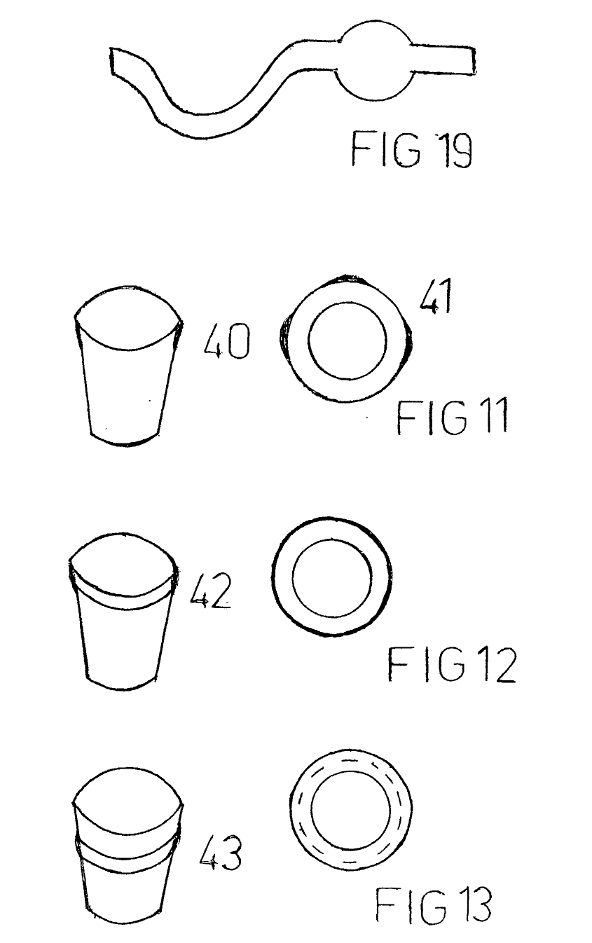

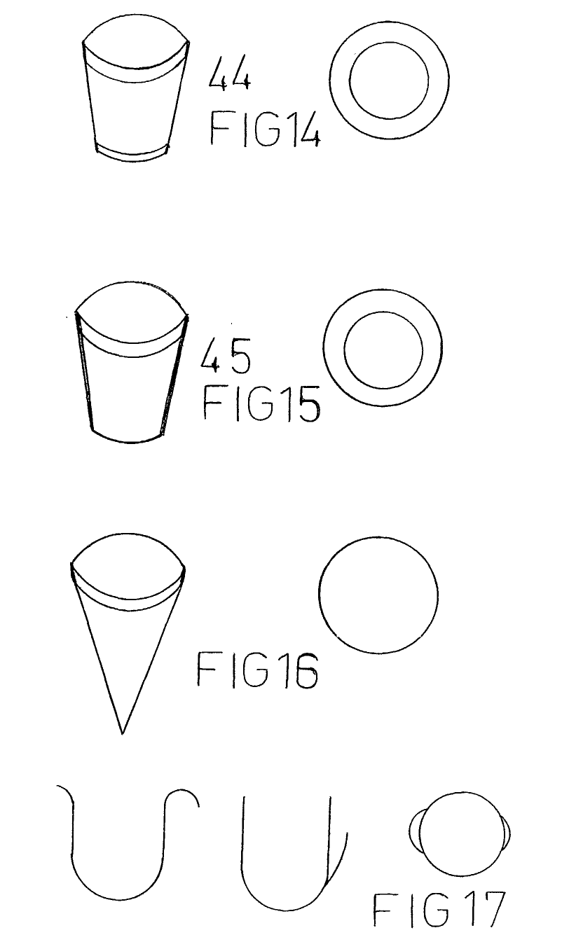

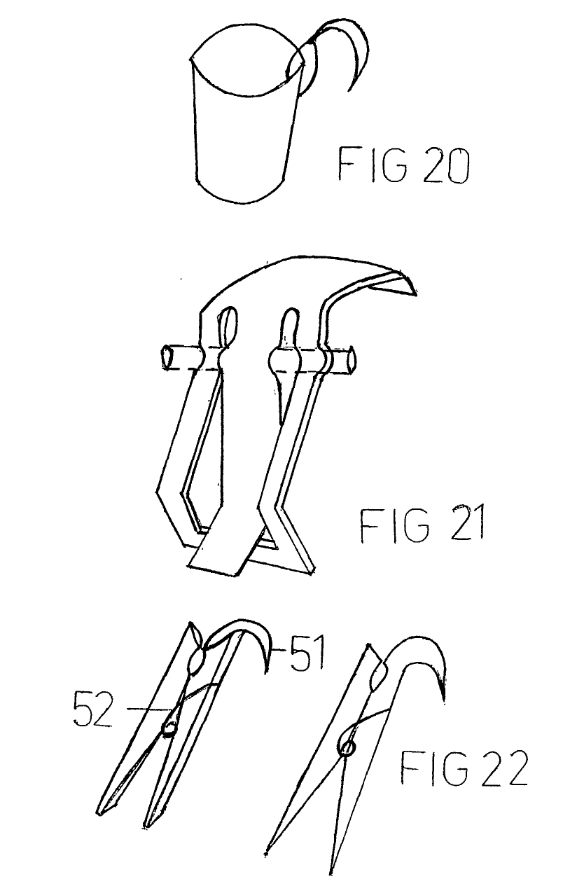

I claim:

1. A mold for manufacturing an article of manufacture, said mold comprising:
a plurality of interfitting divided dies for forming an article of manufacture,
wherein at least two of the plurality of divided dies are connected dies and at least one of said connected dies is a moveable die;
linkage means for connecting said connected dies, and,
means for moving said moveable die from a first position for a first process in the manufacture of said article to a second position in which said moveable die no longer functions in said first process.

2. The mold of claim 1 wherein when in said second position said moveable die functions in a second process in the manufacture of said article.

3. The mold of claim 1 wherein said moveable die is an interchangeable die which can be replaced on the plurality of dies during the manufacturing process to modify the characteristics of the article after the article has been processed by the plurality of divided dies.

4. The mold of claim 1 wherein said mold further comprises at least one die in said mold that is not intermitted with the plurality of interfitted divided dies.

5. The mold of claim 1 wherein said mold works in combination with an external device for producing said article.

6. The mold of claim 1 further comprising a space into which a second article can be molded and/or the article can be held with the mold where not all interfitting dies are required thereby creating an ease in manufacturing the product reducing labour.

7. The mold of claim 1 wherein at least one of said plurality of divided dies further comprises an orifice to permit the monitoring of fluid characteristics within the die.

8. The mold of claim 7 further comprising an adoptive control operatively connected to the orifice.

9. The mold of claim 8 further comprising a plug operatively connected to the orifice to stop flow of fluid in orifice and control fluid in and out of the mold.

10. The mold of and of claims 7 or 8 or 9, wherein said divided dies comprise a plurality of orifices in fluid communication.

11. The mold of any of claims 1 to 10 wherein said means is operatively connected to said linkage means.

12. The mold of claim 11 wherein the means to move divided dies is one or more of the group consisting of motor means, hydraulic means and air piston means.

13. The mold of any of claims 1 to 12 wherein said means is controlled by a programming device.

14. The mold of claim 13 wherein said means can determine the position of said article within said dye and the interfitting dye.

15. The mold of any of claims 1 to 14 wherein said linkage means is a die bolt.

16. The mold of claim 15 comprising at least one manufacturing means for forming or modifying the characteristics of the article applicable to the mold.

17. The mold of claim 15 further comprising a control box which runs, communicates both ways and controls all processes applicable to the mold for producing or manufacturing an article of manufacture.

18. A Machine to manufacture a product by automation comprising; a mold accordingly to claim 15, a rotary table to place mold on, a housing, feed box, at least one manufacturing means for forming and/or modifying the characteristics of the article applicable to the mold, a control box which runs, and communicates both ways and controls all processes applicable to the mold and a computer that communicates to the control box to aid by it's programming ability to adopt new products to manufacture creating flexibility in the system and accuracy and speed and calculations to aid in overall quality control enhancement of the product being produced.

19. A process for manufacturing an article using the mold of any of claims 1 to 15, said process comprising the steps of:
interfitting said plurality of intermitting divided dies for forming an article,
placing raw material for the article within the interfitting divided dies;
causing a first manufacturing operation to occur within said moveable die;
moving said moveable die to said second position so as to facilitate a further manufacturing operation.

20. The process of claim 19, wherein at least one of the divided dies is interfitted in multiple positions with respect to the other divided dies to effect a plurality of processes during the manufacture of the article.

21. The process of any of claims 19 or 20 further comprising the use of a heated wire to facilitate manufacturing.

22. The process of claim 21 further comprising the steps of:
Monitoring the manufacture of said article using external programming device

23. The process of claim 22 further comprising the steps of:
Computerization of the process wherein the computer communicates to the external programming device to aid by it's programming ability to adopt new products to manufacture creating flexibility in the system and accuracy and speed and calculations to aid in quality control enhancement.

24. An article produced in accordance with the process defined in any of claims 19 to 23.

25. The article defined by claim 24, wherein said article is a molded cup comprising:
a bottom,
a sidewall extending upward from said bottom to form a container with an opening;
a handle ring extending around said sidewall to form a grip, said handle ring being convex in cross-section facing outwardly

26. The article of claim 25 wherein the handle ring is formed adjacent to the opening.

27. The article of any of claims 25 to 26 further comprising a clip.

28. The clip in claim 27 comprising two longitudinal arms, each having a transverse groove, the grooves being coaxial; wherein the longitudinal arms extend outward ear like shape for holding purposes.

29. A clothesclip for fastening article to a line, comprising
an elongated arm protruing cane like shape for holding purpose.
